(19) United States
(12) Patent Application Publication
(10) Pub. No.: US 2013/0334154 A1
(43) Pub. Date: Dec. 19, 2013

(54) Modular pegs for drying rack

(71) Applicants: Robert DeLuca, Mastic, NY (US); William Mabanta, Holtsville, NY (US)

(72) Inventors: Robert DeLuca, Mastic, NY (US); William Mabanta, Holtsville, NY (US)

(73) Assignee: ADVANCED APPLICATIONS, LLC

(21) Appl. No.: 13/507,270

(22) Filed: Jun. 18, 2012

(51) Int. Cl. A47G 29/00; F16M 13/02

(52) U.S. Cl. 211/71.01; 248/231.91

(57) ABSTRACT

A drying rack used primarily for air-drying wet glassware, which utilizes modular pegs that are installed on drying racks of differing materials of construction.

### FIELD OF THE INVENTION

The present invention relates to a drying rack, used primarily for air-drying wet glassware, which utilizes modular pegs that are installed on drying racks of differing materials of construction.

### BACKGROUND OF THE INVENTION

Drying racks with pegs are typically used to support wet glassware, allowing it to air dry, and to support other related items. Historically the drying racks have been made from heavy solid materials such as epoxy resin, with a series of aperture drilled through for mounting pegs. More recently, thinner sheet materials, such as stainless steel, have been used to make the drying racks. These thinner materials required a different mounting method, a different aperture pattern and a different peg design than what is used on the thicker, solid material drying racks.

U.S. Pat. No. 5,884,784 relates to a draining laboratory drying rack system comprising a panel having a plurality of apertures formed therein, a plurality of pegs mounted in the apertures for supporting wet laboratory equipment, and a dispensing unit mounted to the panel by hooks on the dispensing unit being received within the apertures.

U.S. Pat. No. 5,163,567 relates to a draining laboratory drying rack system comprises a panel having a plurality of apertures formed therein, a plurality of pegs mounted in the apertures for supporting wet laboratory equipment, a catch drain mounted to the rear of the panel to collect water dripping down the rear of the panel and a drip trough to collect water from the catch drain.

U.S. Pat. No. 3,912,212 relates to a drainboard whose face panel includes inverted triangular shaped apertures for receiving removable pegs. The pegs have a shoulder, an arm extending outwardly from the front of the shoulder, a neck extending rearwardly from the shoulder, and having an inverted triangular shaped cross-section, and an enlarged head on the neck which can be inserted through the aperture in the panel until the shoulder engages the panel. The peg is slid downwardly to lock the peg onto the panel and prevent rotation.

U.S. Pat. No. 4,485,929 relates to a laboratory drying rack system which includes a drying rack mounted on a support structure and a variety of utensil trays supported on the rack. The drying rack includes a drain board with a plurality of noncircular apertures and a plurality of pegs with a plurality of noncircular mounting portions which engage the apertures so that the pegs are releasably secured against the board.

### SUMMARY OF THE INVENTION

The present invention relates to a modular peg that fits into a drying rack of any material (thin sheet or thick solid) with the properly designed aperture pattern.

The present invention relate to a modular peg which comprising a base, one or more protruding post and two protruding studs on the opposite side of the base from the post.

It is an object of the present invention for one or both of the protruding studs to have an undercut or side cut(s) near the base so that the peg is captured in the aperture in thin sheet metal material.

It is an object of the present invention for the protruding studs to be symmetrical so that the peg is installed into the apertures in either up/down orientation.

It is an object of the present invention for one or both of the protruding studs to have a larger diameter bulb at the end of the stud which applies pressure to the inner wall of the aperture in thick solid material.

It is an object of the present invention for the protruding post to extend from the base in various lengths and at various angles to support glassware or other items.

It is an object of the present invention for the protruding post to include a hook or return bend(s) at the end.

It is an object of the present invention for the peg to be constructed of plastic, cast metal, formed sheet metal, wood or other composite materials.

It is an object of the present invention for the aperture pattern within the thin sheet material drying rack to feature two cutouts in a configuration matching the protruding studs on the back of the peg. It is an object of the present invention for one or both of the cutouts to feature a keyhole design wherein the top of the cutout is larger in width than the lower portion of the cutout, allowing the side cuts of the stud to lock into the aperture.

According to the invention, a thin sheet material is defined as material with a thickness of 0.125″ or less.

It is an object of the present invention for the aperture pattern within the thick solid material drying rack to feature two cutouts in a configuration matching the protruding studs on the back of the peg.

### BRIEF DESCRIPTION OF THE DRAWINGS

FIG. 1 illustrates a modular peg of the present invention.

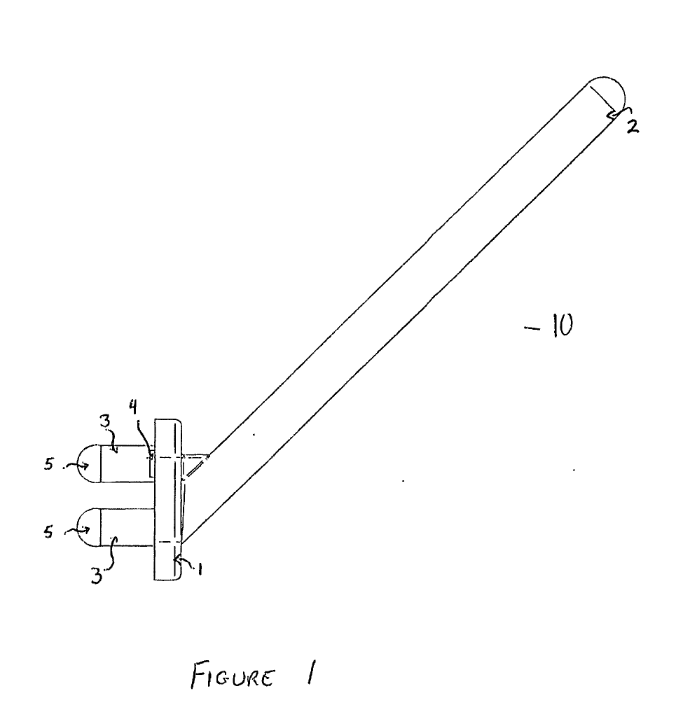

FIG. 2 illustrates the base and protruding studs on the peg of the present invention.

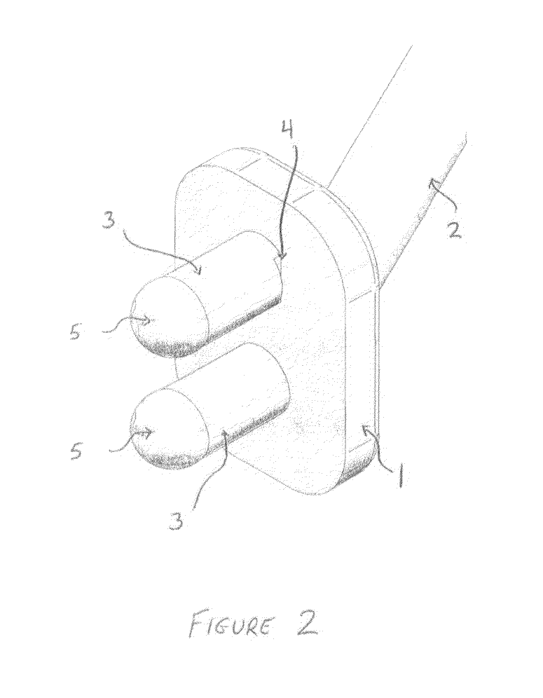

FIG. 3 illustrates a mating aperture pattern for thin sheet material drying racks of the present invention.

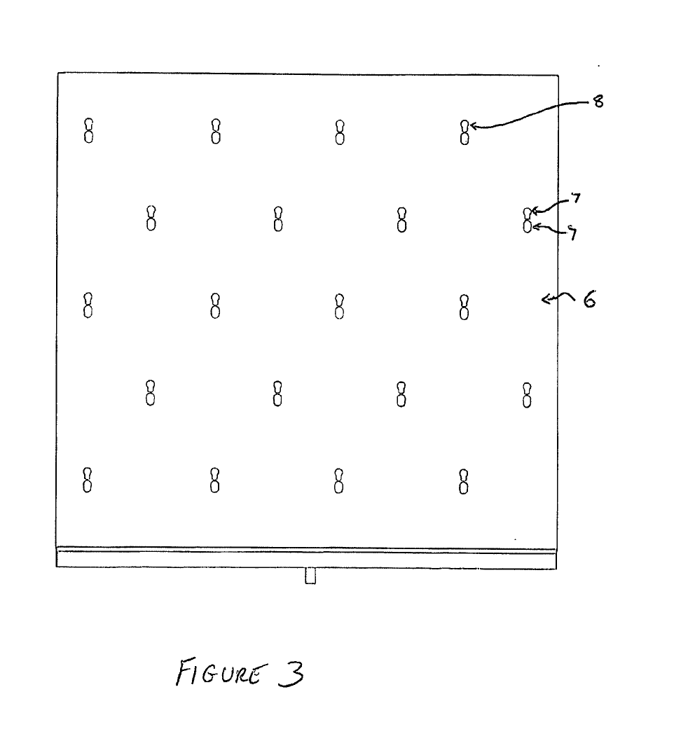

### DETAILED DESCRIPTION OF THE INVENTION

In an embodiment, the invention includes a modular peg 10, which comprises a base 1, one or more protruding post 2, and two protruding studs 3, on the opposite side of the base 1 from the post 2. It is preferred that one or both of the protruding studs 3 has an undercut or side cut(s) 4 near the base 1 so that the peg 10 is captured in the aperture in the thin sheet metal material. It is preferred that the protruding studs 3 are symmetrical so that the peg 10 is installed into the apertures in either up/down orientation.

One or both of the protruding studs 3 has a larger diameter bulb 5 at the end of the stud 3 which applies pressure to the inner wall of the aperture in thick solid material.

In a preferred embodiment, the protruding post 2 extend from the base 1 in various lengths and at various angles to support glassware or other items. The protruding post 2 may include a hook or return bend(s) at the end. The peg 10 may be constructed of plastic, cast metal, formed sheet metal, wood or other composite materials.

In an embodiment, the aperture pattern within the thin sheet material drying rack 6 features two cutouts 7 in a configuration matching the protruding studs on the back of the peg. One or both of the cutouts 7 features a keyhole design 8 wherein the top of the cutout is larger in width than the lower portion of the cutout, so that the side cuts of the stud lock into the aperture. Thin sheet material is defined as material with a thickness of 0.125″ or less.

In an embodiment, the aperture pattern within the thick solid material drying rack features two cutouts in a configuration matching the protruding studs on the back of the peg.

1. A modular peg comprising:
a base,
one or more protruding post and two protruding studs on opposite side of said base;
said one or both of said protruding studs having an undercut or side cut(s) near said base; and
said one or both of said protruding studs having a large diameter bulb at end of said stud that applies pressure to inner wall of an aperture in which said protruding stud is inserted.

2. The modular peg of claim 1 wherein said protruding studs are symmetrical so that said peg is installed into said aperture in either an up or down orientation.

3. The modular peg of claim 1 wherein said one or more protruding post(s) has a hook or return bend(s) at end.

4. A drying rack comprising:
sheet material with a thickness of less than approximately 0.125″
an aperture pattern for accepting one or more pegs;
said pegs comprising a base, one or more protruding post and two protruding studs on opposite side of said base;
said protruding studs are symmetrical.
